(19) United States
(12) Patent Application Publication
(10) Pub. No.: US 2014/0342326 A1
(43) Pub. Date: Nov. 20, 2014

(54) MEMORY CAPTURING, STORING AND RECALLING SYSTEM AND METHOD

(71) Applicant: Jeanne-Louise SHIH, Montreal (CA)

(72) Inventor: Jeanne-Louise SHIH, Montreal (CA)

(21) Appl. No.: 13/894,407

(22) Filed: May 14, 2013

(51) Int. Cl. G09B 5/06; G09B 23/00

(52) U.S. Cl. CPC G09B 5/06; G09B 23/00
USPC 434/236

(57) ABSTRACT

A system and method for capturing, storing and recalling moments within a presentation view. A plurality of data items, preferably video, but not restricted to video, called moment records, whereby each data item has an associated time are captured, stored and encapsulated into larger packets by associating them with a presentation view having a predetermined form herein called a storyboard. Such actions are performed in real time for the benefit of memory recall to the user experiencing and capturing such moments that are intended to be accessed by the user during capture or at a later time.

### CROSS-REFERENCE TO RELATED APPLICATIONS

This application claims the benefits of U.S. provisional patent application No. 61/647,436 filed on May 15, 2012, which is herein incorporated by reference.

### TECHNICAL FIELD

The present disclosure relates to a memory capturing, storing and recalling system and method.

### BACKGROUND

Methods known in the art to help recall events include the use of devices such as surveillance cameras, microphones, video cameras and other monitoring devices. They also include wearable devices such as Microsoft Sensecam™ which is a wearable camera noted for specific use in aid of impaired individuals, for example those afflicted with Alzheimer's disease. The device is used for the purposes of recalling events and parameters associated with a traumatic event such as a patient's injury resulting from a fall. The noted purposes include helping physicians to better understand causes and the extent of injuries or helping parents and teachers to recall events experienced by a child to diagnose behavioral problems.

Though these applications are valid for very specific uses, there is a need for a recall method that may be easily accessible to a mass general public as recalling events or impressions from memory is an exercise experienced by all. With current web and mobile applications, many people are becoming increasingly comfortable with sharing content in the form of text status updates and images. Furthermore, the concept of a timeline is becoming increasingly important and is reflected in several website and mobile phone applications.

Existing popular approaches to timeline are largely focused on the sharing between multiple users of various forms of data in time by way of a serial news stream. Other approaches allow users to be able to edit and introduce new items anywhere along a histogram or a timeline representing the past for the purposes of editing and sharing information with other users. Methods involving video as part of a mobile application for example, are also generally targeted at sharing visual content between many users. These information sharing methods however do not specifically target at ensuring the integrity of past moments to the user nor do they provide a method of facilitating the accurate search and recall of such past memories for the benefit of the user.

In particular the need is for moments in a person's life to be captured, stored and recalled in a meaningful manner. The purpose would be to optimize the integrity of the moments by a visual presentation mechanism in order to remind of the original impressions experienced by the user. What is needed is that the user who is capturing moments may visually organize his or her moments in real time or may be able to access and observe his or her moments being visually organized in real time as they are being captured either by the user himself or automatically for example with a capturing device. The recall in this case is to visually recall the set of moments to the user as they had been first visually organized during the capture of moments. This is such that the visual presentation is able to support and present captured moments in digestible packets generally in the same manner in both instances of capturing and of recalling moments to the user and preferably, but not restricted to a two dimensional format where the user may see many of his or her moments immediately. In this sense, what is needed is an immediate and maximized visual presentation of several moments to optimize recall to a user.

In particular, the recall method that is needed is one that would target the user who is capturing the moments and not at generally sharing data with other users. The method must also help to provide a quick and easy way of searching and accessing accurately such moments that were deemed meaningful to the user and prevent the user from having to recall events or personal impressions by sifting through a continuous stream of recorded video or reliving continuous streams of recorded data in a single news stream or in a serial manner. Shortcomings of existing art that recall events, for example through video recall, involve the recall of moments in continuous time. Such recall methods have a targeted use as an analysis tool such as with Sensecam™ by someone with a technical knowledge over human behavior or health for example in order to analyze the continuous captured data. Other applications involve image sorting or image sharing that provide a means to present images of the past along a histogram, a calendar or a timeline as a means of organizing and viewing visual data after capture, much like a photo album.

The idea that memory recall is a personal experience which involves emotion and attention calls for the visual presentation of such moments in such a way that the overall impression of a collection of moments captured may be strengthened visually and that this visual presentation be accessible to the user during the generation and the recall of moments. The requirement of sifting through many moments or reliving a continuous stream of past moments in conventional methods may not be particularly appealing as a meaningful recall method to the general public.

Accordingly, there is a need for a memory capturing, storing and recalling system and method that addresses the above-described shortcomings.

### SUMMARY

The present disclosure provides a system and method for capturing, storing and recalling moments within a presentation view. A plurality of data items, preferably video, but not restricted to video, herein called moment records, whereby each data item has an associated time are captured, stored and encapsulated into larger packets by associating them with a presentation view having a predetermined form herein called a storyboard. Such actions are performed in real time for the benefit of memory recall to the user experiencing and capturing such moments that are intended to be accessible by the user during capture and at any later time.

Accordingly, there is provided a computing device implemented method for the memory recall of moment records, the method comprising:
generating at least one storyboard having a predefined number of display areas each being adapted to display an associated moment record in a predetermined form on a single display page;
importing the moment records, each moment record having an associated time;
storing the imported moment records in association with the associated time;
associating each of the stored moment records with one of the display areas of the at least one storyboard based on the associated time; and
upon recalling of a selected stored moment record displaying the storyboard associated with the selected stored moment record.

There is also provided a method as above, further comprising associating at least one of the stored moment records with a first parameter and wherein recalling of the selected moment record is based on at least the first parameter.

There is also provided a method as above, further comprising associating at least one of the at least one storyboard with a second parameter and further comprising upon recalling of a selected storyboard displaying the selected storyboard, wherein recalling of the selected storyboard is based on at least the second parameter.

There is further provided a system implemented on a computing device for the memory recall of moment records, comprising:

a capturing device configured for:
generating moment records;
associating a time with each of the generated moment records;

a database;

an interface;

a display;

a processor in communication with the capturing device, the database, the interface and the display, the processor configured for:
generating at least one storyboard having a predefined number of display areas each being adapted to display an associated moment record in a predetermined form on a single page on the display;
importing the moment records with the associated time from the capturing device;
storing the imported moment records with the associated time in the database;
associating each of the stored moment records with one of the display areas of the at least one storyboard based on the associated time;
allowing a user to recall through the interface a selected stored moment record; and
upon recalling of a selected stored moment record displaying in the display the storyboard associated with the selected stored moment record.

There is also provided a system as above, wherein the processor is further configured for associating at least one of the stored moment records with a first parameter and wherein recalling of the selected moment record is based on at least the first parameter.

There is also provided a system as above, wherein the processor is further configured for associating at least one of the at least one storyboard with a second parameter and further comprising upon recalling of a selected storyboard displaying the selected storyboard, wherein recalling of the selected storyboard is based on at least the second parameter.

### BRIEF DESCRIPTION OF THE FIGURES

Embodiments of the disclosure will be described by way of example only with reference to the accompanying drawings, in which:

FIG. 1 is a schematic representation of the memory capturing, storing and recalling system in accordance with an illustrative embodiment of the present invention;

FIG. 2 is an illustrative embodiment of the presentation view executed by the presentation application used by the memory capturing, storing and recalling system of FIG. 1;

FIG. 3 is a schematic diagram of an illustrative example of the data exchange architecture used by the memory capturing, storing and recalling system of FIG. 1; and

FIG. 4 is a flow diagram of an illustrative example of the timeline capture application procedure used by the memory capturing, storing and recalling system of FIG. 1.

Similar references used in different Figures denote similar components.

### DEFINITIONS

Moment record: is a record of a user's experience in the form of a video clip, an audio clip, a still image, a text, a link to external data, etc., which is relevant to the user and captured or chosen in real time. “Relevancy” is defined by either the user's personal choice in real time or predefined settings/conditions associated with a capture device.

Storyboard: is a space on a single display page in which a cluster of up to a predefined number of moments records that are captured sequentially in time are presented for viewing.

Metadata: includes tags such as a hashtags or text, audio tags, video tags, a link to external data or other such identifiers that is assigned onto a moment and/or a storyboard. This metadata may be assigned according to the content of the moment record or storyboard, according to parameters set by the capture device of the moment record or according to predefined preferences set by the user. The metadata may also include information such as time stamps.

### DETAILED DESCRIPTION

Generally stated, the non-limitative illustrative embodiment of the present disclosure provides a system and method for the capturing, storing and recalling of moments experienced in real time in the form of video clips and in an alternative embodiment may also include, but is not limited to, audio clips, still images, texts, links to external data, etc., for the purpose of the generation and the recall of personal memories. The recall is supported by the visual presentation of moment records in a maximized view to a user, with the visual presentation of the moment records being the same over time.

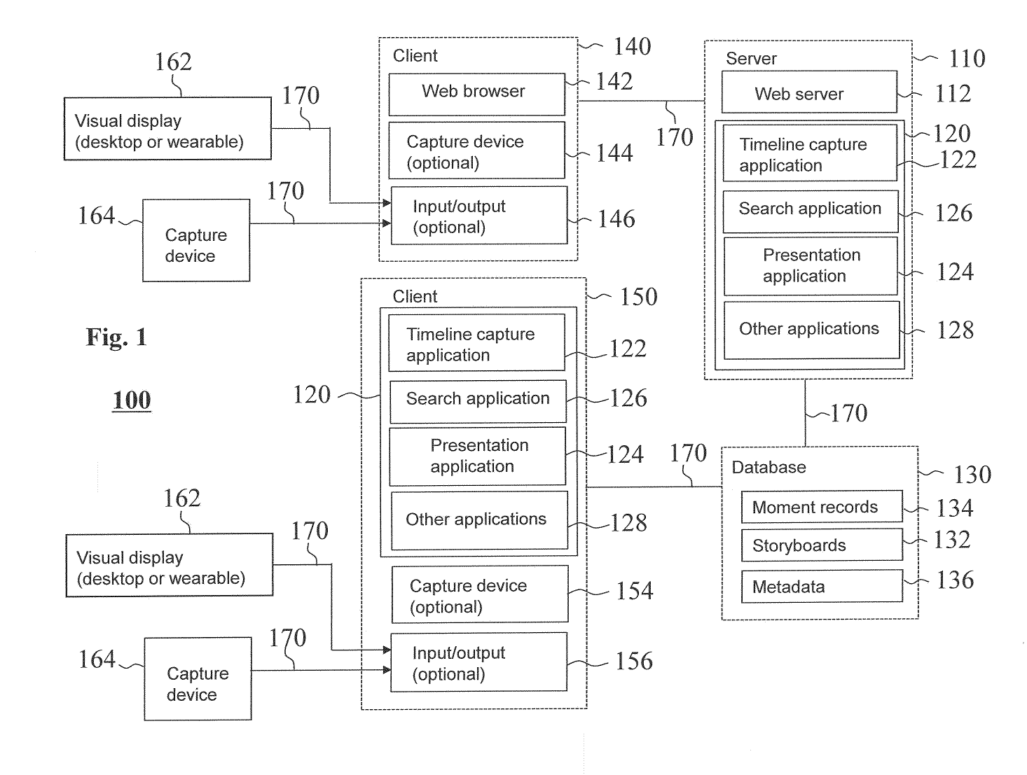

Referring to FIG. 1, the memory capturing, storing and recalling system 100 generally comprises a server 110, a database 130, at least one client device 140, 150, at least one visual display 162 and at least one capture device 164, which may be interconnected via various connections 170 such as, for example, Ethernet (broadband, high-speed), wireless WiFi, cable internet, satellite connection LAN, WAN, serial connection, cellular or satellite network, etc.

The server 110 includes a web server 112 and a set of memory capturing, storing and recalling support applications 120 composed of a timeline capture application 122, a presentation application 124, a search application 126 and other applications 128.

The database 130 is configured to store therein one or more storyboards 132, moment records 134, metadata 136. As defined, storyboards 132 contain clusters of moment records 134 associated with one another in time. Moment records 134 are records of a user's experience in the form of a video clip and in an alternative embodiment may also include an audio clip, a still image, a text, a link to external data, etc., which is relevant to the user. These are preferably captured in real time and organized in sequential time. Metadata 136 includes tags such as hashtag text identifiers, audio tags or other such identifiers that is assigned onto a moment record 134 and/or a storyboard 132. This metadata 136 may be assigned according to the content of the moment record 134 or storyboard 132, according to predefined preferences by the user or according to parameters defined by the capture device 144, 154, 164 such as, for example, a time stamp from a camera.

It is to be understood that although throughout the disclosure reference is made to separate server 110 and database 130, these may be implemented on one or more or physical devices and may also be combined. It is to be further understood that the database 130 may equally be implemented by a data structure within a computer memory or may be implemented directly as part of client device 150.

The timeline capture application 122 is executed by either the server 110 or the client 150 to import and store moment records 134 in the form of video clips and in an alternative embodiment may also include audio clips, still images, texts, links to external data, etc. The timeline capture application 122 will be further described below.

The presentation application 124 is executed by either the server 110 or the client 150 to display moment records 134 associated with a storyboard 132 in a presentation view defined by the presentation application 124 such as for example a presentation view to visually organize and display the moment records 134 in a 1D, 2D or 3D display form. A user may be able to request via a button, portal, link and so forth the display page showing the storyboard 132 containing moment records 134 according to the presentation view defined by the presentation application 124.

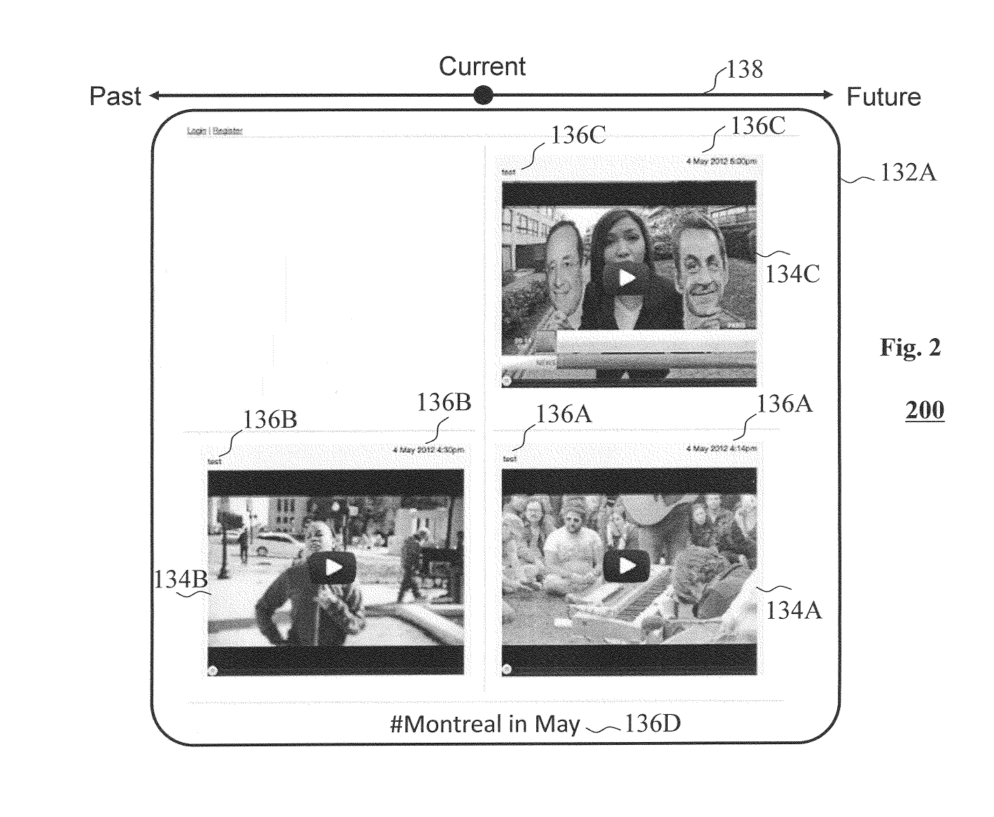

Referring to FIG. 2, the presentation view defined by the presentation application 124 in this illustrative example is in a 2D display form such that moment records 134 are visually organized and displayed in storyboard 132A as a grid of up to a predefined number of moment records 134 on a visual display 162, in this example up to four moment records 134. Upon the capture, import and storing of a moment record 134A, the presentation application 124 executes to display it in the storyboard 132A with the assigned metadata 136A. Several minutes later, a new moment record 134B is captured, imported and stored and the presentation application 124 executes to display it in the storyboard 132A alongside moment record 134A. Metadata 136B which was assigned to moment record 134B is also displayed. Several minutes later, moment record 134C is captured, imported, stored with metadata 136C assigned to it and displayed in storyboard 132A. In this illustrative example, moment records 134A, 134B and 134C are therefore associated with storyboard 132A. It is to be understood that if more than four moment records 134 are captured, a new storyboard 132 will be created. Storyboard 132A may be recalled by the user according to metadata 136A, 136B, 136C with the intention of recalling either moment record 134A, 134B, 134C or of recalling storyboard 132A by the search application 126 which will be further described below. The recall of one moment record 134A for example, prompts a recall of the moment records 134B and 1340. Metadata 136A, 136B, 136C may be assigned by a user or automatically by the capture device 144, 154, 164. The user may view on the display 162 via a button, portal, link and so forth the storyboard 132A as the moment records 134A, 134B or 134C for example are captured, visually organized and displayed as part of storyboard 132A. In an alternative embodiment, metadata 136D may be assigned by a user or automatically by the capture device 144, 154, 164 to the storyboard 132A. In a further alternative embodiment, a timeline 138 may be displayed along with the storyboard 132A. In further still embodiments, the timeline 138 may indicate effective dates and times and/or may be used to navigate between storyboards 132.

The search application 126 is executed by either the server 110 or the client 150 to search for storyboards 132 and for moment records 134 associated with storyboards 132 using their associated metadata 136. For example, a user may use the search application 126 to search for the metadata 136 in the form of a hashtag text identifier such as the tag #Montreal and all storyboards 132 having such an associated metadata 136 or storyboards 132 containing a moment record 134 having such an associated metadata 136 will be provided to the presentation application 124 for display from client devices 140, 150 onto displays 162. In this case the searched metadata 136 #Montreal will contain context derived from being associated with a storyboard 132 or associated with a moment record 134 as part of a storyboard 132 and visually organized in a segment of time by the presentation application 124. As described earlier by way of the illustrative example presented in FIG. 2, the storyboard 132A gives a time-wise context while the other moment records 134A, 134B, 1340 that are part of the storyboard 132A provide environmental, situational, emotional, visual, audio, etc., context. According to some embodiments, all storyboards 132 associated with the searched term #montreal as either an identifier associated to a storyboard 132 such as for example the identifier 136D in FIG. 2 or to a moment record 134 contained within a storyboard 132 may all be viewed serially, in time sequence by the user via a button, portal, link and so forth.

Referring again by way of example to FIG. 2, the recall is aided by the visual organization and presentation of captured moment records 134 in each storyboard 132 as a grid up to a predefined number of moment records 134, in this example up to four moment records 134, consistently over time. The user may view on the display 162 via a button, portal, link and so forth the most recent storyboard 132A as moment records 134A, 134B, 1340 are captured, visually organized and displayed and equally, the user may also view former storyboards 132 and moment records 134 associated with storyboards that had also been previously organized and presented in the same manner as a grid of up to four moment records 134 via a button, portal, link and so forth. The user in this example therefore over time, visually associates four moment records 134 captured sequentially in time with one another within a storyboard having a presentation view as a 2D grid of up to four moment records 134.

The presentation application 124 is therefore also executed by either the server 110 or the client device 150 to display the results of the search application 126, i.e. storyboards 132, or previews of storyboards 132 containing moment records 134 with the client device 140, 150 in the appropriate time sequence. The moment records 134 within a storyboard 132 are displayed in 2D, but in an alternative embodiment may be displayed in 1D and 3D. Referring again to FIG. 2, by way of example, if a user wants to recall a specific moment record 1340 and searches for it by entering metadata tag 136C as a search term in the search application 126, the presentation application 124 may according to some embodiments execute and display storyboard 132A associated with moment record 1340 as being the most recent storyboard 132 among many storyboards 132 associated with metadata 136C or containing at least one moment record 134 associated with metadata 136C.

In 1D, the moment records 134 are displayed in a single row within one storyboard 132 and are arranged sequentially in time for example from left to right.

In 2D, the moment records 134 are displayed in a grid of moment records 134 within one storyboard 132, arranged sequentially in time, for example from left to right, top to bottom, with the rightmost bottom moment record 134 being the oldest.

In 3D, the moment records 134 are displayed in multiple superimposed grids arranged sequentially in time, for example from left to right, top to bottom, front to back, with the rightmost bottom moment record 134 at the back being the oldest.

As for the storyboards 132, they may also be displayed in 1D, 2D or 3D sequentially in time along one another in the same manner described for moment records 134.

The other applications 128 include various applications such as, for example, video transcoders and other multimedia applications to be executed by either the server 110 or the client 150 in order to support the media types used to record moment records 134 or to convert to different formats that may be used by the presentation application 124 to present moment records 134 in the storyboard 132.

The client devices 140, 150 are of two main types, a first client device 140 type includes a web or mobile browser 142 which may allow users to access a website hosted on the server 110 in order to access the memory capturing, storing and recalling support applications 120 while the second client device 150 type includes a local version of the memory capturing, storing and recalling support applications 120. Accordingly, client device 140 uses the server 110 in order to store, search and retrieve storyboards 132 and moment records 134 from the database 130 while client device 150 can directly do so, i.e. can connect directly to database 130.

Client devices 140, 150 may also optionally include one or more capture device 144, 154 and/or input/output 146, 156.

According to some embodiments one client device 140, 150 may only serve to import and store to the database 130 moment records 134 captured by a capture device 144, 154, 164 via the timeline capture application 122 while another client device 140, 150 may serve to display the captured moment records 134 and storyboards 132 to at least one display 162 according to the presentation view defined by the presentation application 124 by accessing the database 130.

The input/output 146, 156 may be a combination of various input and output interfaces such as one or more universal serial bus (USB), firewire, Bluetooth™, card reader (i.e. for CF, SD, XQD, etc.), HMDI, RJ-45 Ethernet, etc. The input/output 146, 156 is used by the client device 140, 150 to input a moment record 134 from an external capture device 164 and to output storyboards 132 and moment records 134 to an external visual display 162.

Client devices 140, 150 include, but are not limited to, smart phones, tablet PCs, personal digital assistants (PDA), wearable devices, personal or laptop computers or still and video cameras.

The capture devices 144, 154, 164 is used to capture moment records 134 and may be, for example, still or video cameras, audio recorder, etc.

The capture device 164, as a separate device, may be, for example, a still or video camera, an audio recorder, a personal or laptop computer, etc., used to capture moment records 134 to be provided to the client 140, 150.

Visual display 162 includes, but is not limited to, a desktop, mobile or wearable display.

Other devices that may be used as a capture device 164 and/or visual display device 164 include wearable accessories such as Brother's Airscout™ wearable display which may come attached with a camera or body monitoring devices such as a wireless electroencephalogram (EEG) headsets or other wearable headsets and smart bracelets.

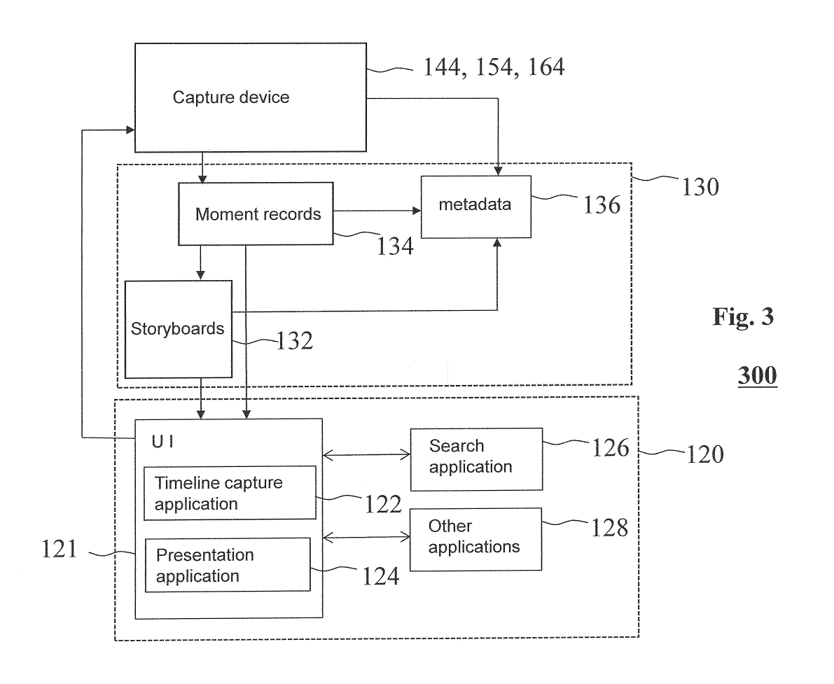

Referring now to FIG. 3, there is shown an illustrative example of the data exchange architecture between the main components of the memory capturing, storing and recalling system 100.

Data from the capture devices 144, 154, 164, for example a video clip, an audio clip, a still image, a text, a link to external data, etc., is stored into the database 130 as a moment record 134 in its original format or, optionally, in a specific format using other applications 128 such as a transcoder. Simultaneously, related parameters or data may be stored as metadata 136 associated with the moment record 134, for example user data or global positioning system (GPS) coordinates of where the moment record 134 was captured.

The moment record 134 is then associated with a storyboard 132 in a time sequence manner according to the presentation view defined by the presentation application 124 and associated metadata 136 stored. It should be noted that the moment records 134 may also be made available to storyboards 132 other than those of the user or the database 130 through sharing with other client devices 140 150 from users connected to one another over a network via connections 170.

The storyboards 132 are arranged sequentially and associated metadata 136 stored. The storyboards 132 and moment records 134 are made available to user interface 121.

User interface (UI) 121 is composed of the timeline capture application 122 and the presentation application 124. The timeline capture application 122 manages the import of data from the capture devices 144, 154, 164 into the database 130 as well as the association of the moment records 134 with storyboards 132 and their associated metadata 136. The presentation application 124 manages the display of such moment records 134 associated with a storyboard 132 according to the predetermined presentation view defined by the presentation application 124. The user may be able to request via a button, portal, link and so forth the display page showing the storyboard 132 containing moment records 134 displayed according to the presentation view parameters defined by the presentation application 124 as they are captured and managed by the timeline capture application 122. The presentation application 124 also manages the use of and the display of search results from the search application 126 which according to some embodiments provide a list of storyboards 132 and moment records 134 related to specific search parameters by accessing the metadata 136 associated with the storyboards 132 and moment records 134. As mentioned previously, the search results in the form of storyboards 132 and associated moment records 134 may be displayed in 1D, 2D or 3D. The UI 121 may use the other applications 128 to, for example, convert and store moment records 134 in a specific or user selectable format using a transcoder or display the moment records 134 in a desired format such as, for example, .ogg, .mp4, .webm, etc.

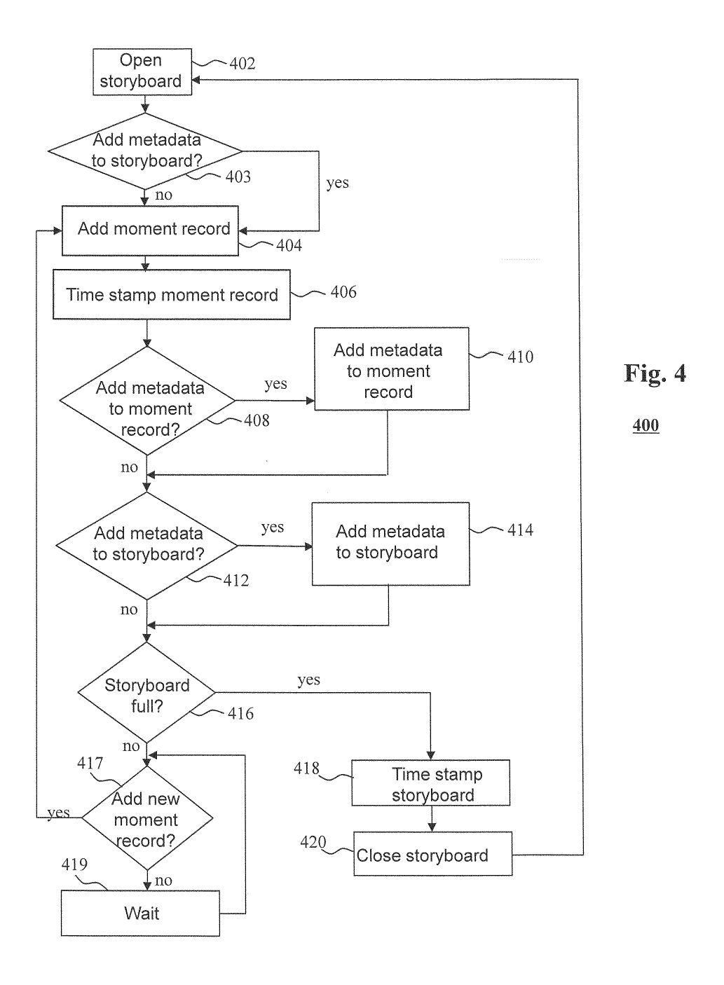

Referring to FIG. 4, there is shown a flow diagram of an illustrative example of the procedure 400 which is executed by the timeline capture application 122. The steps of the procedure 400 are indicated by blocks 402 to 420.

The procedure 400 starts at block 402 where a new storyboard 132 is created in the database 130 at which time the user may add, if desired, associated metadata 136. Other metadata may also be automatically associated with the storyboard 132.

At block 404, a moment record 134 is imported in real time into the database 130 in the form of a video clip and in an alternative embodiment also in the form of an audio clip, still image, text, link to external data, etc. This may be performed via a capture device 144, 154, 164.

The moment record 134 may be captured and added either by the user according to personal need or taste in one embodiment. In another embodiment the moment record 134 may be added as an automatic response to pre-settings on a capture device 144, 154, 164 that may be set by a user. For example, a camera device with a motion sensor that may automatically track movements such as steps, distance traveled, calories burned, pace, intensity level, activity, etc. or devices that may output brain imaging data during emotional activity may be integrated to the system in order to trigger the capture of a moment 134 automatically for the user according to pre-settings on such capture devices 144, 154, 164.

At block 406, the moment record 134 is time stamped with an associated time which may be the time in which it was generated or added to the storyboard 132. Depending on the capture device 144, 154, 164 used to create the moment record 134 and its functionalities, and if enabled/desired by the user, other metadata 136 may also be automatically associated with the moment record 134. In one embodiment for example, global positioning system (GPS) coordinates of where the moment record 134 was captured may be added as metadata 136 associated with the moment record 134.

At block 408, procedure 400 verifies if the user desires to add metadata 136 to the moment record 134. If so, it proceeds to block 410 where the user is prompted to add the metadata 136 to be associated with the moment record 134, after which it proceeds to block 412. Optionally, metadata 136 tied to output from a client 140, 150 or a capturing device 144, 154, 164 may be automatically added. For example, a #excited tag may be added to the moment record 134 when the user's heart rate increases above a given value as may have been indicated by the output from client 140, 150 or capturing device 144, 154, 164. If the user does not desire to add metadata 136 to the moment record 134, the procedure 400 proceeds directly to block 412.

Optionally, at block 412, procedure 400 verifies if the user desires to add metadata 136 to the storyboard 132. If so, it proceeds to block 414 where the user is prompted to add the metadata 136 to be associated with the storyboard 132, after which it proceeds to block 416. If the user does not desire to add metadata 136 to the storyboard 132, the procedure 400 proceeds directly to block 416.

At block 416, procedure 400 determines whether the storyboard 132 contains the maximum allowed number of moment records 134 to be associated with the storyboard 132 as defined by the presentation application 124. If the maximum number is reached and the storyboard 132 may not accept another moment record 134 in the presentation view as defined by the presentation application 124, it proceeds to block 418. If the maximum number is not reached, it proceeds to block 417.

At block 417, procedure 400 verifies if the user desires to add another moment record 134 to the storyboard 132. If so, it proceeds back to block 404 where the new moment record 134 is added. If the user does not desire to add another moment record 134, the procedure 400 proceeds to block 419 and waits for the user to add a new record 134.

At block 418, the storyboard 132 is time stamped with either the time stamp of the first moment record 134 or the time stamp of the last moment record 134 added onto the storyboard 132 or both of these time stamps or any associated time related to the creation or closing of the storyboard 132.

At block 420, the storyboard 132 is closed in the database 130. It is to be understood that other metadata 136 may also be automatically associated with the storyboard 132 at this point.

The procedure 400 then proceeds back to block 402 where a new storyboard 132 may be created.

In an alternative embodiment, moment records 134 may be shared by users over a network to be inserted within each other's storyboards 132, in real time. For example, at block 404 of procedure 400 (see FIG. 4) the user may choose to add a moment record 134 to a friend's storyboard 132. The moment record 134 is passed to the friend's storyboard 132, as well as his or her own storyboard 132 and these may be kept or deleted from either storyboards 132 by either parties.

Storyboards 132 which are available to a user may be based on pre-set availability parameters, for example the owner of a storyboard 132 may select users that are allowed to add moment records 134, may make a storyboard 132 public so that anyone may add a moment record 134 or a moment record 134 added by another user may simply be left pending until approval by the owner of the storyboard 132. Optionally, the owner of the storyboard 132 may amend the metadata 136 associated with the added moment record 134 and may associate new metadata 136 with it.

This sharing of moment records 134 or storyboards 132 is performed in real time and allows friends to share moment records 134 and have them encapsulated into each other's storyboards 132 in sequential time order. Accordingly, the storyboards 132 and moment records 134 may be stored in various databases and/or data structures and shared over a network.

It is to be understood that although moment records 134 may be of various types, e.g. video clip, audio clip, still image, text, link to external data, etc., in a first illustrative embodiment of the memory capturing, storing and recalling system 100 the moments records 134 are all video clips. In a second illustrative embodiment of the memory capturing, storing and recalling system 100 the moment records 134 are all of a similar type, i.e. either video clip or audio clip or still image or text or link to external data, etc., and in a third illustrative embodiment of the memory capturing, storing and recalling system 100 the moment records 134 are of mixed types, i.e. a combination of one or more of video clip, audio clip, still image, text, link to external data, etc.

It is to be further understood that the server 110 and client devices 140, 150 are provided with processors and associated memories having stored therein processor executable code for the execution of the memory capturing, storing and recalling support applications 120, web server 112 and web browser 142.

Although the present disclosure has been described with a certain degree of particularity and by way of an illustrative embodiments and examples thereof, it is to be understood that the present disclosure is not limited to the features of the embodiments described and illustrated herein, but includes all variations and modifications within the scope and spirit of the disclosure as hereinafter claimed.

What is claimed is:

1. A computing device implemented method for the memory recall of moment records, the method comprising:
generating at least one storyboard having a predefined number of display areas each being adapted to display an associated moment record in a predetermined form on a single display page;
importing the moment records, each moment record having an associated time;
storing the imported moment records in association with the associated time;
associating each of the stored moment records with one of the display areas of the at least one storyboard based on the associated time; and
upon recalling of a selected stored moment record displaying the storyboard associated with the selected stored moment record.

2. The method of claim 1, further comprising associating at least one of the stored moment records with a first parameter and wherein recalling of the selected moment record is based on at least the first parameter.

3. The method of claim 2, wherein the first parameter is selected from a group consisting of a time stamp, a metadata tag, a global positioning system coordinate, a video clip, an audio clip, a still image, a text and a link.

4. The method of claim 2, wherein the first parameter is associated to the moment record based on an operation by the user.

5. The method of claim 2, wherein the moment record is imported from a capturing device generating the first parameter and the first parameter is associated to the moment record based on an operation of the capturing device.

6. The method of claim 1, further comprising associating at least one of the at least one storyboard with a second parameter and further comprising upon recalling of a selected storyboard displaying the selected storyboard, wherein recalling of the selected storyboard is based on at least the second parameter.

7. The method of claim 6, wherein the second parameter is selected from a group consisting of a time stamp, a metadata tag, a global positioning system coordinate, a video clip, an audio clip, a still image, a text and a link.

8. The method of claim 6, wherein the second parameter is associated to the storyboard based on an operation by the user.

9. The method of claim 6, wherein the moment record is imported from a capturing device generating the second parameter and the second parameter is associated to the storyboard based on an operation of the capturing device.

10. The method of claim 1, wherein the predetermined form is selected from a group consisting of a one dimensional display form, a two dimensional display form and a three dimensional display form.

11. The method of claim 1, wherein the moment records are selected from a group consisting of a video clip, an audio clip, a still image, a text and a link.

12. The method of claim 1, wherein importing the moment records includes receiving the moment records through sharing from another user over a network.

13. A system implemented on a computing device for the memory recall of moment records, comprising:
a capturing device configured for:
generating moment records;
associating a time with each of the generated moment records;
a database;
an interface;
a display;
a processor in communication with the capturing device, the database, the interface and the display, the processor configured for:
generating at least one storyboard having a predefined number of display areas each being adapted to display an associated moment record in a predetermined form on a single page on the display;
importing the moment records with the associated time from the capturing device;
storing the imported moment records with the associated time in the database;
associating each of the stored moment records with one of the display areas of the at least one storyboard based on the associated time;
allowing a user to recall through the interface a selected stored moment record; and
upon recalling of a selected stored moment record displaying in the display the storyboard associated with the selected stored moment record.

14. The system of claim 13, wherein the processor is further configured for associating at least one of the stored moment records with a first parameter and wherein recalling of the selected moment record is based on at least the first parameter.

15. The system of claim 14, wherein the first parameter is selected from a group consisting of a time stamp, a metadata tag, a global positioning system coordinate, a video clip, an audio clip, a still image, a text and a link.

16. The system of claim 14, wherein the first parameter is associated to the moment record based on an operation of the user.

17. The system of claim 14, wherein the first parameter is associated to the moment record based on an operation of the capturing device.

18. The system of claim 13, wherein the processor is further configured for associating at least one of the at least one storyboard with a second parameter and further comprising upon recalling of a selected storyboard displaying the selected storyboard, wherein recalling of the selected storyboard is based on at least the second parameter.

19. The system of claim 18, wherein the second parameter is selected from a group consisting of a time stamp, a metadata tag, a global positioning system coordinate, a video clip, an audio clip, a still image, a text and a link.

20. The system of claim 18, wherein the second parameter is associated to the storyboard based on an operation of the user.

21. The system of claim 18, wherein the second parameter is associated to the storyboard based on an operation of the capturing device.

22. The system of claim 13, wherein the predetermined form is selected from a group consisting of a one dimensional display form, a two dimensional display form and a three dimensional display form.

23. The system of claim 13, wherein the moment records are selected from a group consisting of a video clip, an audio clip, a still image, a text and a link.

24. The system of claim 13, wherein the processor is further configured for importing the moment records through sharing from another user over a network.

25. The system of claim 13, wherein the capturing device is selected from a group consisting of a smart phone, a tablet device, a personal digital assistant, a wearable device, a personal computer, a laptop computer, a still camera and a video camera.
